(19) United States
(12) Patent Application Publication
(10) Pub. No.: US 2025/0122911 A1
(43) Pub. Date: Apr. 17, 2025

(54) ELECTROMAGNETICALLY ACTUATED DOG CLUTCH AND METHOD OF MOUNTING A SHIFTING SLEEVE OF AN ELECTROMAGNETICALLY ACTUATED DOG CLUTCH

(71) Applicant: Hoerbiger Antriebstechnik Holding GmbH, Schongau (DE)

(72) Inventors: Juergen BINDER, Schongau (DE); Peter ECHTLER, Schongau (DE); Andreas DEMPFLE, Schongau (DE); Wemer FUERGUTH, Schongau (DE); Wolfgang VOELK, Schongau (DE); Oleg BUTORIN, Schongau (DE); Sebastian KUCHAREK, Schongau (DE)

(21) Appl. No.: 18/917,433

(22) Filed: Oct. 16, 2024

(30) Foreign Application Priority Data
Oct. 17, 2023 (DE) 102023128458.4

(51) Int. Cl. F16D 27/09; F16D 11/14

(52) U.S. Cl. CPC F16D 27/09; F16D 11/14

(57) ABSTRACT

An electromagnetically actuated dog clutch includes a shifting sleeve which has an internal toothing and is received axially movably on an external toothing of a transmission shaft for joint rotation therewith, an actuator which has a magnet coil and is configured so as to be adapted to move the shifting sleeve axially on the transmission shaft into a first shifting position, a spring element which cooperates with the shifting sleeve and acts upon the shifting sleeve in a direction opposite to a movement caused by the actuator in the direction of a second shifting position, and a support ring which is plugged onto the transmission shaft and is arranged in an axial direction of the shifting sleeve between the spring element and the internal toothing of the shifting sleeve. The support ring is firmly connected to the transmission shaft with respect to the axial direction. To mount the shifting sleeve onto the transmission shaft, an assembly is formed by arranging the support ring and the spring element on the shifting sleeve, and the assembly is pushed onto the external toothing of the transmission shaft up to a predetermined end position of the support ring, the support ring being axially fixed on the transmission shaft at the predetermined end position.

### TECHNICAL FIELD

The present disclosure relates to an electromagnetically actuated dog clutch having a shifting sleeve and to a method of mounting a shifting sleeve of an electromagnetically actuated dog clutch on a transmission shaft.

### BACKGROUND

In electromagnetically actuated dog clutches, the shifting sleeve is usually electromagnetically attracted into one of the two shifting positions by a magnetic field generated by a coil and is biased into the other shifting position by a spring. The spring must therefore be positioned within the clutch assembly and be supported against the reaction forces.

Accordingly, an object of the present disclosure is to reduce the space required for an electromagnetically actuated dog clutch, e.g. in the radial direction, while also making it easy to mount.

### SUMMARY

The present disclosure discloses an electromagnetically actuated dog clutch, comprising a shifting sleeve which has an internal toothing and is received axially movably on an external toothing of a transmission shaft for joint rotation therewith, an actuator which has a magnet coil and is configured so as to be adapted to move the shifting sleeve axially on the transmission shaft into a first shifting position, a spring element which cooperates with the shifting sleeve and acts upon the shifting sleeve in a direction opposite to a movement caused by the actuator in the direction of a second shifting position, and a support ring, which is plugged onto the transmission shaft and is arranged in an axial direction of the shifting sleeve between the spring element and the internal toothing of the shifting sleeve and which is firmly connected to the transmission shaft with respect to the axial direction.

In some implementations, as the support ring is fixed directly on the transmission shaft, a radially very compact assembly is achieved, which can be mounted, for example, by simply pressing it axially onto the transmission shaft.

In some implementations, the external toothing of the transmission shaft is formed, for example, on a known clutch body which is connected to the transmission shaft for joint rotation therewith and axially adjacent to which a idler gear having an external toothing to be coupled is arranged. The idler gear and the transmission shaft are adapted to be connected for joint rotation by the internal toothing of the shifting sleeve engaging in the external toothings thereof to shift the respective gear.

In some implementations, the dog clutch can be designed as a normally open clutch, so that the first shifting position corresponds to a closed position and the second shifting position to an open position of the dog clutch. However, the principle of the disclosure can also be realized with a normally closed dog clutch.

In some implementations, the support ring has a resting surface for the spring element against the force transmitted by the shifting sleeve and forms a reaction surface for the spring element which points in the axial direction.

In some implementations, the support ring is for example an axially rigid metal ring and is always a component separate from the transmission shaft and the external toothing thereof. For example, the support ring has sufficient elasticity in the radial direction to be pushed onto the external toothing of the transmission shaft. Generally, the support ring may be made of a spring material to prevent plastic deformation as much as possible.

In some implementations, the spring element consists, for example, of several disk springs which are arranged axially next to each other on the external toothing of the transmission shaft.

In one variant, the shifting sleeve is composed of a plurality of components which are firmly connected to each other. For example, the shifting sleeve has an engagement ring on which the internal toothing is formed, and a shift ring which is firmly connected to the engagement ring and cooperates with the actuator, the shift ring being arranged radially outside the engagement ring and the support ring being arranged axially next to the engagement ring. In this way, the spring element and the support ring can be easily integrated into a prefabricated assembly for mounting the shifting sleeve. Furthermore, it is thus for example easy to realize a shifting sleeve made of several different materials, having different magnetic and mechanical properties, for example.

In some implementations, the shift ring can consist of a ferromagnetic material to be adapted to be displaced by the actuator. In a variant, a reluctance force is generated in the shift ring by the magnetic field of the actuator, which pulls the shifting sleeve closer to the actuator to maximize the inductance in the magnetic circuit.

In some implementations, the shifting sleeve may have a receptacle for the support ring and the spring element. To this end, the shift ring may extend axially over the support ring and the spring element, that is, it can be arranged radially outside the support ring and the spring element. In addition, the support ring should have a lateral axial stop for the spring element, which couples the spring element to the shifting sleeve and transmits a spring force of the spring element to the shifting sleeve. The spring element can be arranged between the axial stop and the support ring and clamped axially between these components.

In some implementations, the support ring may be radially shorter than the engagement ring and radially spaced from the shift ring. In this way, magnetic flux from the shift ring to the support ring can be reduced. Since the support ring does not contribute to the shifting force, it is e.g. made of a non-ferromagnetic material.

In some implementations, the internal toothing of the shifting sleeve has for example a plurality of radial stop projections, each of which cooperates with a stop groove in the external toothing of the transmission shaft and defines an end position of the shifting sleeve in the second shifting position of the dog clutch. For example, some of the teeth of the internal toothing respectively have a radial projection which is positioned axially so as to rest against the axial end of the associated stop groove when the shifting sleeve is in the second shifting position.

In some implementations, the stop projections, which are in contact with an end face of a idler gear in the first shifting position, can be used to limit the shifting travel into the first shifting position and thus to define the first shifting position.

It is possible to surround a magnet coil of the actuator with an annular actuator housing, which together with the shift ring forms the magnetic circuit of the actuator.

In some implementations, the support ring may have a resting surface for the shifting sleeve on which geometric structures are formed which reduce contact between the shifting sleeve and the support ring. The structures should be designed to reduce adhesive forces, for example due to an oil film and/or magnetic forces between the support ring and the shifting sleeve. For example, the support ring may have an L-shape in a section in the axial direction or projections distributed along the radial and/or circumferential direction. The surface of the shifting sleeve which comes into contact with the resting surface is, for example, a side face of the engagement ring.

In some implementations, the aforementioned object is also achieved with a method of mounting a shifting sleeve of an electromagnetically actuated dog clutch on a transmission shaft, as described above. To this end, the following steps are carried out:
forming an assembly by arranging the support ring and the spring element on the shifting sleeve, and
pushing the assembly onto the external toothing of the transmission shaft up to a predetermined end position of the support ring, the support ring being axially fixed on the transmission shaft at the predetermined end position.

To produce the assembly, the engagement ring, the support ring and the spring element can be lined up axially before the shift ring is placed radially over these elements and welded to the engagement ring. In this way, the receptacle is formed and the support ring and the spring element are at the same time arranged in the receptacle. The support ring and the spring element can thus be easily pre-assembled on the shifting sleeve so that they can be handled together as a single component. This assembly then only needs to be pushed to the desired axial position on the external toothing of the transmission shaft. Initially, the support ring usually rests against a side face of the engagement ring and is pushed by the latter onto the transmission shaft.

In some implementations, the radial stop projections and stop grooves mentioned above can define the predetermined end position for the support ring. When the assembly is pushed onto the external toothing of the transmission shaft, the sliding movement stops when the stop projections come to rest against the axial end of the stop grooves. The support ring thus reaches its correct axial position on the transmission shaft without any further action. Tolerances in the assembly are thus also automatically compensates for.

In the predetermined end position, the support ring is automatically fixed axially on the transmission shaft, e.g. without any further work steps.

In some implementations, to fix the support ring on the transmission shaft, it can be held in the predetermined end position solely by frictional forces on the transmission shaft. For this purpose, a closed support ring can be used. This has the advantage that the support ring does not generate any unbalance. This variant is therefore particularly suitable for high speeds.

In some implementations, the support ring is pushed onto the transmission shaft with a higher axial force than that applied by the actuator when the dog clutch is shifted, so that the support ring cannot be displaced during normal operation of the clutch.

If necessary, pushing on can be assisted by the application of heat, which causes a temporary radial expansion of the support ring so that it can be moved to the predetermined end position on the transmission shaft. When cooling down, the support ring contracts again and is thus firmly clamped on the transmission shaft.

In a further variant, the support ring is fixed on the transmission shaft by the support ring engaging in a radial groove in the external toothing of the transmission shaft in the predetermined end position. In this case, the support ring is slotted so that it can expand sufficiently in the radial direction to be pushed over the transmission shaft until it reaches the radial groove. This variant is particularly suitable for low speeds.

In some implementations, to simplify the mounting of the component and, in particular, the pushing of the support ring onto the transmission shaft, the support ring is e.g. pushed onto a chamfer at one axial end of the external toothing of the transmission shaft and thereby expanded radially. The chamfer may be formed at the axial ends of the teeth of the external toothing of the transmission shaft. This chamfer simultaneously centers the support ring correctly on the transmission shaft when it is pushed thereon.

### BRIEF DESCRIPTION OF THE DRAWINGS

FIG. 1 shows a schematic exploded view of an assembly of an electromagnetically actuated dog clutch according to the disclosure, before mounting on a transmission shaft using a method according to the disclosure;

FIGS. 2 and 3 show schematic, perspective, partially cut views of the dog clutch of FIG. 1 in an open and a closed position;

FIGS. 4 and 5 show schematic sectional views of the dog clutch of FIG. 1 in an open and a closed position;

FIG. 6 shows a schematic side view of the dog clutch of FIG. 1;

FIGS. 7 and 8 show schematic sectional views of the dog clutch of FIG. 1 in an open and a closed position;

FIG. 9 shows a further schematic sectional view of the dog clutch of FIG. 1 during mounting of the shifting sleeve on the transmission shaft;

FIGS. 10 to 12 show schematic sectional views of different variants of a support ring of the dog clutch of FIG. 1; and

FIGS. 13 and 14 show schematic top views of different variants of the support ring.

### DETAILED DESCRIPTION

For reasons of clarity, all identical components are not always provided with reference numerals.

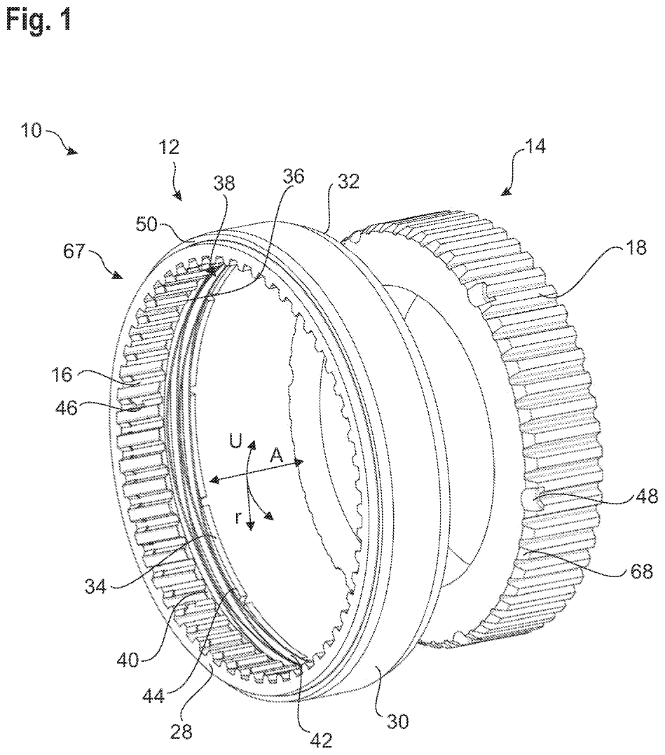

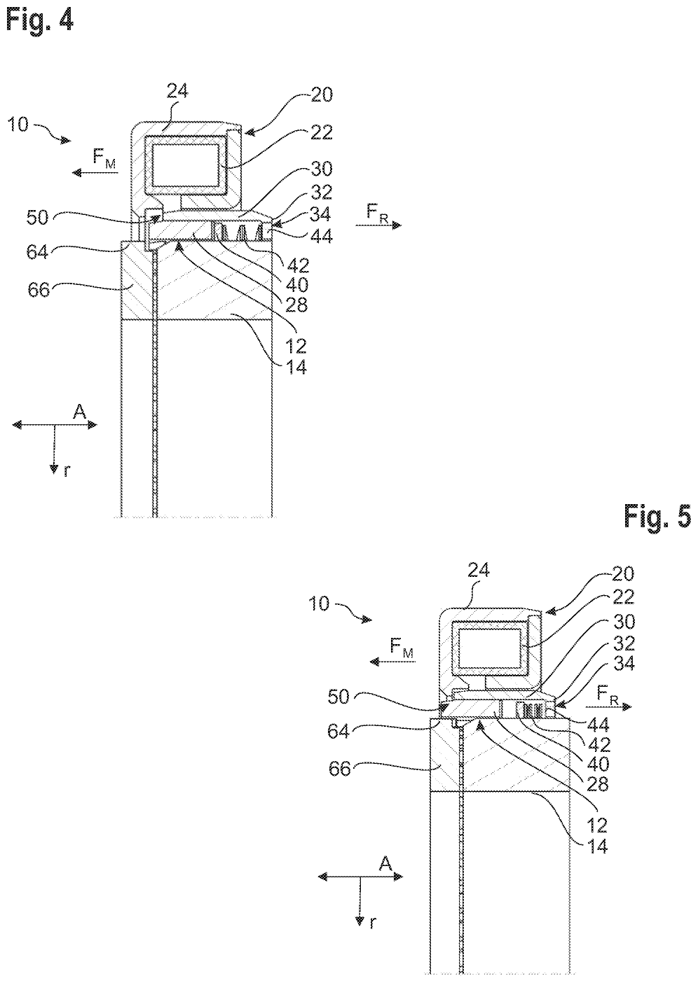

FIGS. 1 to 8 show an electromagnetically actuated dog clutch 10 comprising a shifting sleeve 12 which is received on a transmission shaft so as to be movable in the axial direction A but is also received for joint rotation therewith in the peripheral direction U of the transmission shaft 14. The shifting sleeve 12 has an internal toothing 16, while the transmission shaft 14 is provided with a matching external toothing 18.

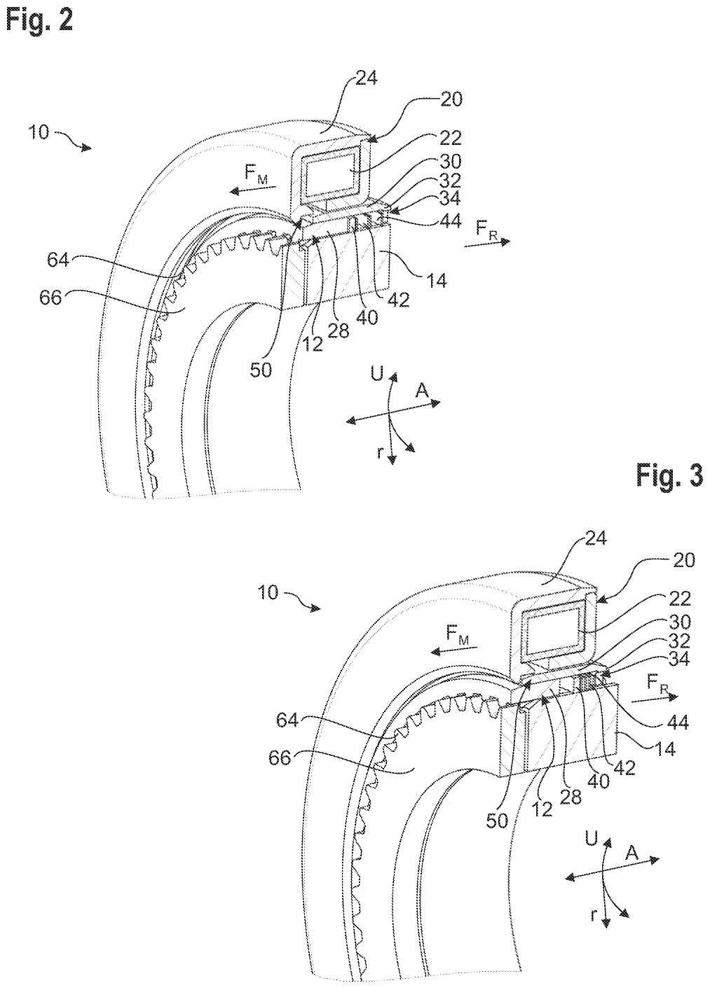

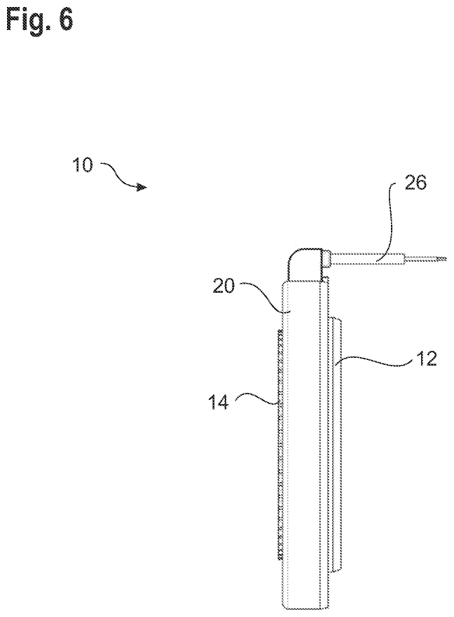

As can be seen in FIGS. 2 to 6, the shifting sleeve 12 is surrounded in the radial direction r by an actuator 20, which comprises a magnet coil 22 which can be energized and an actuator housing 24. A current supply to the magnet coil 22 is provided via suitable electrical connections 26, as shown in FIG. 6.

When the actuator 20 is activated, a magnetic force FM acts on the shifting sleeve 12 and moves it into a first shifting position, which in this example corresponds to a closed position of the dog clutch 10. This first shifting position is shown in FIGS. 3, 5 and 8.

The shifting sleeve 12 is composed here of an engagement ring 28 and a shift ring 30 which is arranged radially outside the engagement ring 28 and firmly connected thereto. The internal toothing 16 is present only on the engagement ring 28. The radial inner side of the shift ring 30 is designed to be smooth. At its first axial end 32 facing away from the engagement ring 28, the shift ring 30 has a radial projection 34 which extends in the direction towards the transmission shaft 14.

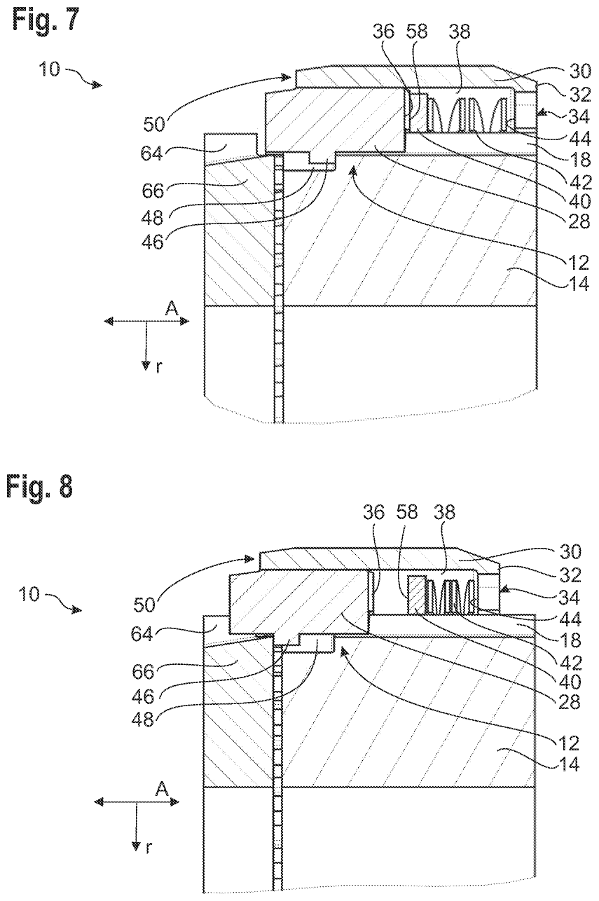

Between the radial projection 34, the radial inner side of the shift ring 30 and a side face 36 of the engagement ring 28, a receptacle 38 is formed, in which a support ring 40 and a spring element 42 are received, which are each of an annular design and are pushed onto the transmission shaft 14 (see, for example, FIGS. 7 and 8).

The support ring 40 is firmly secured to the transmission shaft 14 axially and optionally also in the circumferential direction U at a predetermined end position.

The spring element 42 can be compressed in the axial direction A by the movement of the shifting sleeve 12 and can relax to move the shifting sleeve 12 axially back out of the first shifting position into a second shifting position. The second shifting position corresponds here to an open position of the dog clutch 10 and is shown in FIGS. 2, 4 and 7.

The radial projection 34 forms an axial stop 44 for the spring element 42, which transmits a restoring force FR generated by the spring element 42 to the shifting sleeve 12. On its side opposite the axial stop 44, the spring element 42 rests against a side face of the support ring 40 which forms a second axial stop for the spring element 42 and absorbs the reaction force of the spring element 42 and dissipates it into the transmission shaft 14.

One respective radial stop projection 46 is formed on some teeth of the internal toothing 16 of the engagement ring 28 of the shifting sleeve 12, the stop projections 46 being distributed over the circumference of the shifting sleeve 12 so as to cooperate with stop grooves 48 on the external toothing 18 of the transmission shaft 14 (see FIGS. 1, 7 and 8). The axial depth of the stop grooves 48 and the axial position of the stop projections 46 limit the axial movement of the shifting sleeve 12 in the direction of the second shifting position and thus also define the axial position of the second shifting position.

The first shifting position is here determined by the stop projections 46 resting against an end face of the idler gear 66.

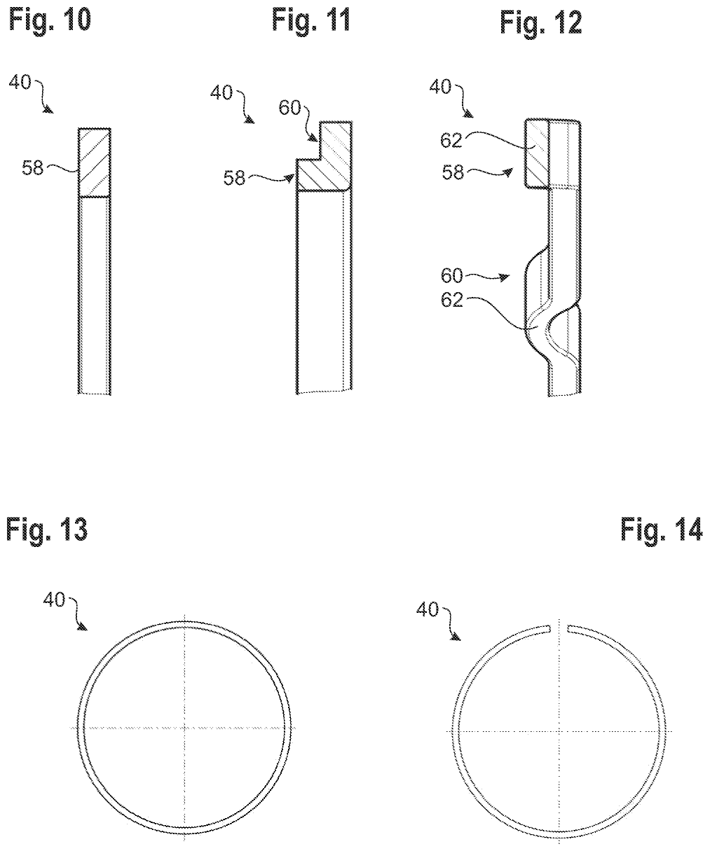

In the second shifting position, the shifting sleeve 12, more precisely a side face 36 of the engagement ring 28, is in contact with a resting surface 58 of the support ring 40 which points in the axial direction. To reduce adhesive forces between these two components, which arise from an oil film and/or magnetic forces between the side face 36 and the resting surface 58, the resting surface 58 may comprise one or more geometric structures 60 which minimize contact between the resting surface 58 of the side face 36 as far as possible. Variants thereof are shown in FIGS. 11 and 12, while FIG. 10 shows a simple flat support ring 40.

In the example of FIG. 11, the resting surface 58 is L-shaped in a section in the radial direction r along the axial direction A, so that only a narrow ring comes into contact with the side face 36 of the engagement ring 58.

In the example of FIG. 12, a plurality of axial projections 62 is formed with respect to the radial direction r and/or the circumferential direction U at different positions of the resting surface 58, the resting surface 58 coming into contact with the side face 36 only in the region of the projections 62.

During operation of the electromagnetic dog clutch 10, the actuator 20 is energized when the dog clutch 10 is to be closed. The magnetic field of the magnet coil 22 creates a reluctance force FM in the shift ring 30, which pulls the latter radially under the actuator housing 24 to form a magnetic circuit that is as closed as possible and to maximize the total inductance. Thus, the shifting sleeve 12 is moved in the direction of the first shifting position until the shifting sleeve 12 has reached the first shifting position.

In this position, the internal toothing 16 of the engagement ring 28 of the shifting sleeve 12 has moved axially so far that it comes into engagement with an external toothing 64 of a idler gear 66, which is arranged axially directly adjacent to the external toothing 18 of the transmission shaft 14, and the external toothing 18 of the transmission shaft 14 couples with the external toothing 64 of the idler gear 66, so that the transmission shaft 14 and the idler gear 66 are connected for joint rotation to each other.

Due to the displacement of the shifting sleeve 12, the spring element 42 is compressed between the support ring 40 and the axial stop 44 at the projection 34 of the shift ring 30 and builds up the restoring force FR.

If the dog clutch 10 is to be opened again, the energization of the magnet coil 22 of the actuator 20 is terminated. The force FM caused by the magnetic field now stops, and the shifting sleeve 12 is pushed back axially in the opposite direction into the second shifting position by the restoring force FR applied by the spring element 42. The axial displacement ends in the second shifting position when the stop projections 46 rest against the axial end of the stop grooves 48. The internal toothing 16 of the engagement ring 28 then disengages from the external toothing 64 of the idler gear 66, so that the transmission shaft 14 and the idler gear 66 are decoupled again.

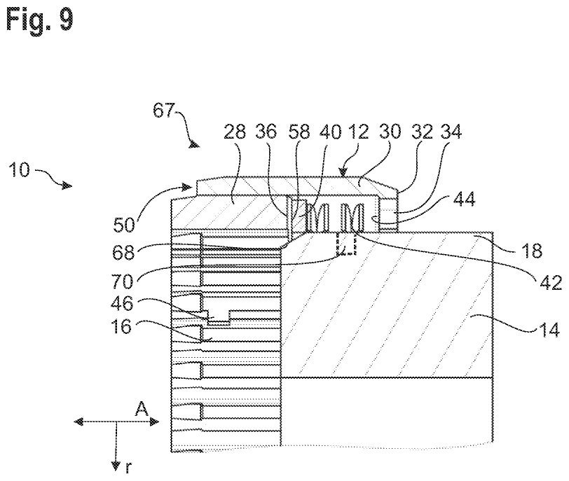

To mount the shifting sleeve 12 on the external toothing 18 of the transmission shaft 14, an assembly 67 is first formed. To this end, the engagement ring 28, the support ring 40 and the spring element 42 are arranged axially next to each other. The shift ring 30 is placed radially on an outer side of the engagement ring 28 and fixed there, e.g. by welding. Thus, the receptacle 38 is formed between the side face 36 of the engagement ring 28 and the radial projection 34 of the shift ring 30, and the support ring 40 and the spring element 42 are at the same time accommodated in the receptacle 38 (see FIGS. 1 and 9).

This assembly 67 is now pushed as a whole in axial direction A onto the external toothing 18 of the transmission shaft 14. This movement is supported by a chamfer 68 at the axial end of the external toothing 18 (see FIGS. 1 and 9). The chamfer 68 centers the support ring 40 and expands it radially so that it can be pushed onto the external toothing 18 under radial tension. During this movement, the support ring 40 is moved in the axial direction A by the side face 36 of the engagement ring 28. This movement ends when the stop projections 46 on the internal toothing 16 of the engagement ring 28 reach the axial end of the respective stop grooves 48. The support ring 40 is now in its predetermined end position. Due to the mounting performed in this way, the predetermined end position is precisely aligned with the position of the shifting sleeve 12 at the end of the shifting travel in the direction of the second shifting position.

In a first variant, which is shown in FIG. 13, the support ring 40 is closed in the circumferential direction U. In this case, the support ring 40 is fixed on the transmission shaft 14 purely by frictional forces. The mounting can be supported, for example, by heating the components, a temporary expansion of the support ring 40 in the radial direction r being thus caused.

In a second variant, which is shown in FIG. 14, the support ring 40 is open in the circumferential direction U, i.e. it is slotted, which makes it easier to expand the support ring 40 when pushing it onto the transmission shaft 14. In this case, the external toothing 18 of the transmission shaft 14 has a radial groove 70 at the predetermined end position of the support ring 40 (indicated in FIG. 9), into which the support ring 40 snaps.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An electromagnetically actuated dog clutch comprising:
a shifting sleeve which has an internal toothing and is received axially movably on an external toothing of a transmission shaft for joint rotation therewith, an actuator which has a magnet coil and is configured so as to be adapted to move the shifting sleeve axially on the transmission shaft into a first shifting position,
a spring element which cooperates with the shifting sleeve and acts upon the shifting sleeve in a direction opposite to a movement caused by the actuator in the direction of a second shifting position, and
a support ring, which is plugged onto the transmission shaft and is arranged in an axial direction of the shifting sleeve between the spring element and the internal toothing of the shifting sleeve and which is firmly connected to the transmission shaft with respect to the axial direction.

2. The dog clutch according to claim 1, wherein the shifting sleeve has an engagement ring on which the internal toothing is formed, and a shift ring which is firmly connected to the engagement ring and interacts with the actuator, wherein the shift ring is arranged radially outside the engagement ring and the support ring is arranged axially next to the engagement ring.

3. The dog clutch according to claim 2, wherein the shifting sleeve has a receptacle for the support ring and the spring element, and wherein the shift ring extends axially over the support ring and the spring element and has a lateral axial stop for the spring element.

4. The dog clutch according to claim 1, wherein the internal toothing of the shifting sleeve has a plurality of radial stop projections which each interact with a stop groove in the external toothing of the transmission shaft and define an end position of the shifting sleeve in the second position of the dog clutch.

5. The dog clutch according to claim 4, wherein in the first shifting position, the stop projections are in contact with an end face of a idler gear.

6. The dog clutch according to claim 1, wherein the support ring has a resting surface for the shifting sleeve, on which geometric structures are formed which reduce contact between the shifting sleeve and the support ring.

7. A method of mounting a shifting sleeve of an electromagnetically actuated dog clutch according to claim 1 on a transmission shaft, comprising:
forming an assembly by arranging the support ring and the spring element on the shifting sleeve, and
pushing the assembly onto the external toothing of the transmission shaft up to a predetermined end position of the support ring, the support ring being axially fixed on the transmission shaft at the predetermined end position.

8. The method according to claim 7, wherein the support ring is held in the predetermined end position on the transmission shaft solely by frictional forces.

9. The method according to claim 7, wherein in the predetermined end position, the support ring engages in a radial groove in the external toothing of the transmission shaft.

10. The method according to claim 7, wherein the support ring is pushed onto a chamfer at an axial end of the external toothing of the transmission shaft and is thereby expanded radially.
